(19) United States
(12) Patent Application Publication
(10) Pub. No.: US 2018/0194344 A1
(43) Pub. Date: Jul. 12, 2018

(54) SYSTEM AND METHOD FOR AUTONOMOUS VEHICLE NAVIGATION

(71) Applicant: Faraday&Future Inc., Gardena, CA (US)

(72) Inventors: Chongyu Wang, San Jose, CA (US); Yizhou Wang, San Jose, CA (US)

(21) Appl. No.: 15/662,643

(22) Filed: Jul. 28, 2017

Related U.S. Application Data
(60) Provisional application No. 62/368,937, filed on Jul. 29, 2016.

(51) Int. Cl. B60W 30/06; G05D 1/02; G05D 1/00

(52) U.S. Cl. CPC B60W 30/06; G05D 1/0255; G05D 1/0088; G05D 1/0257; G05D 1/0236; G05D 1/027

(57) ABSTRACT

A system that performs a method is disclosed. The system receives a current vehicle position from a position sensor. The system autonomously navigates a vehicle along a stored navigational path based on a comparison between the current vehicle position and one or more of a plurality of waypoints associated with the stored navigational path. While autonomously navigating the vehicle along the stored navigational path, the system determines, using the proximity sensor, whether an obstacle is present proximate to the vehicle. In accordance with a determination that the obstacle is present proximate to the vehicle, the system halts the autonomous navigation of the vehicle. In some examples, the position sensor includes a global positioning system receiver and the proximity sensor is an ultrasonic proximity sensor.

### CROSS-REFERENCE TO RELATED APPLICATIONS

This application claims the benefit of U.S. Provisional Application No. 62/368,937, filed Jul. 29, 2016, the entirety of which is hereby incorporated by reference.

### FIELD OF THE DISCLOSURE

This relates generally to automated parking of a vehicle based on a pre-recorded path determined from recorded location data using GPS and ultrasonic sensors.

### BACKGROUND OF THE DISCLOSURE

Modern vehicles, especially automobiles, increasingly use systems and sensors for detecting and gathering information about the vehicle's location. Autonomous vehicles can use such information for performing autonomous driving operations. Many autonomous driving actions rely on cooperation from a multitude of sensors including cameras, LIDAR, and ultrasonic sensing, among others. Combining these measurement techniques into navigation commands for a vehicle can be computationally intensive and complicated. In some cases, the sensors used for one navigation operation (e.g., highway driving) may be poorly matched to another navigation operation, such as a relatively simple navigation tasks such as parking a vehicle in a designated (e.g., reserved) parking space, a garage, or the like.

### SUMMARY OF THE DISCLOSURE

Examples of the disclosure are directed to systems and methods for performing autonomous parking maneuvers. The vehicle can use stored information about a navigation path that can be recorded while a driver is controlling the vehicle. At a subsequent time, the vehicle can be instructed to perform an autonomous parking maneuver according to the stored navigation path corresponding to the particular location. For example, a first navigation path may start at one end of a driveway, and end with the vehicle parked in a garage. A second navigation path may begin at a designated vehicle drop off zone at a workplace and end at a reserved parking space (e.g., a space that is always at the same recorded location). By employing the use of one or more stored parking routes, a vehicle can utilize Global Positioning System (GPS) and/or other Global Navigation Satellite System (GNSS) techniques to autonomously replicate the navigation maneuvers of a driver on a recorded parking route. An inertial measurement unit (IMU) can also optionally be employed to provide information about the vehicle's heading, speed, acceleration and the like. By further employing proximity sensors, such as ultrasonic sensors, a vehicle can autonomously perform collision avoidance by stopping the vehicle when a nearby object is detected. Thus, as will be described in more detail below, the combination of GPS (or enhanced GPS) and ultrasonic sensors can be used to safely navigate a vehicle over a pre-recorded route in an autonomous parking maneuver—in some examples, without the use of other, potentially computationally intensive, sensors, such as cameras, LIDAR, RADAR, etc. While the terms “autonomous” and “autonomous navigation” are referred to herein, it should be understood that the disclosure is not limited to situations of full autonomy. Rather, fully autonomous driving systems, partially autonomous driving systems, and/or driver assistance systems can be used while remaining within the scope of the present disclosure.

### BRIEF DESCRIPTION OF THE DRAWINGS

FIGS. 1A-1E illustrate generation and navigation of an exemplary autonomous parking navigation path and collision avoidance according to examples of the disclosure.

FIG. 2 illustrates an exemplary data structure for storing position information for a stored navigation path according to examples of the disclosure.

FIG. 3 illustrates a flow diagram of a recording sequence according to examples of the disclosure.

FIG. 4 illustrates an exemplary autonomous parking process for executing an autonomous parking maneuver according to examples of the disclosure.

FIG. 5 illustrates an exemplary system block diagram of vehicle control system according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples.

Some vehicles, such as automobiles, may include various systems and sensors for estimating the vehicle's position and/or orientation. Autonomous vehicles can use such information for performing autonomous driving and/or parking operations. In many instances, a driver will repeat an identical or nearly identical parking maneuver on a daily basis. For example, a driver may drive onto a driveway of their home, and subsequently navigate the vehicle into a garage. As another example, a driver may drive to a parking lot, enter the parking lot entrance and then navigate the vehicle into a designated or reserved parking space. As part of the navigation, the driver may follow an approximately identical route each time the parking maneuver is completed, while remaining aware of pedestrians and other vehicles and avoiding potential collisions. By employing the use of one or more stored parking routes, a vehicle can utilize Global Positioning System (GPS) and/or other Global Navigation Satellite System (GNSS) techniques to autonomously replicate the navigation maneuvers of a driver on a recorded parking route. An inertial measurement unit (IMU) can also optionally be employed to provide information about the vehicle's heading, speed, acceleration and the like. By further employing proximity sensors, such as ultrasonic sensors, a vehicle can autonomously perform collision avoidance by stopping the vehicle when a nearby object is detected. Thus, as will be described in more detail below the combination of GPS (or enhanced GPS) and ultrasonic sensors can be used to safely navigate a vehicle over a pre-recorded route in an autonomous parking maneuver—in some examples, without the use of other, potentially computationally intensive, sensors, such as cameras, LIDAR, RADAR, etc. It should be appreciated that in the examples described herein a LIDAR and/or RADAR sensor(s) can be used instead of, or in conjunction with an ultrasonic sensor (e.g., a LIDAR device may be used instead of an ultrasonic sensor). While the terms “autonomous” and “autonomous navigation” are referred to herein, it should be understood that the disclosure is not limited to situations of full autonomy. Rather, fully autonomous driving systems, partially autonomous driving systems, and/or driver assistance systems can be used while remaining within the scope of the present disclosure.

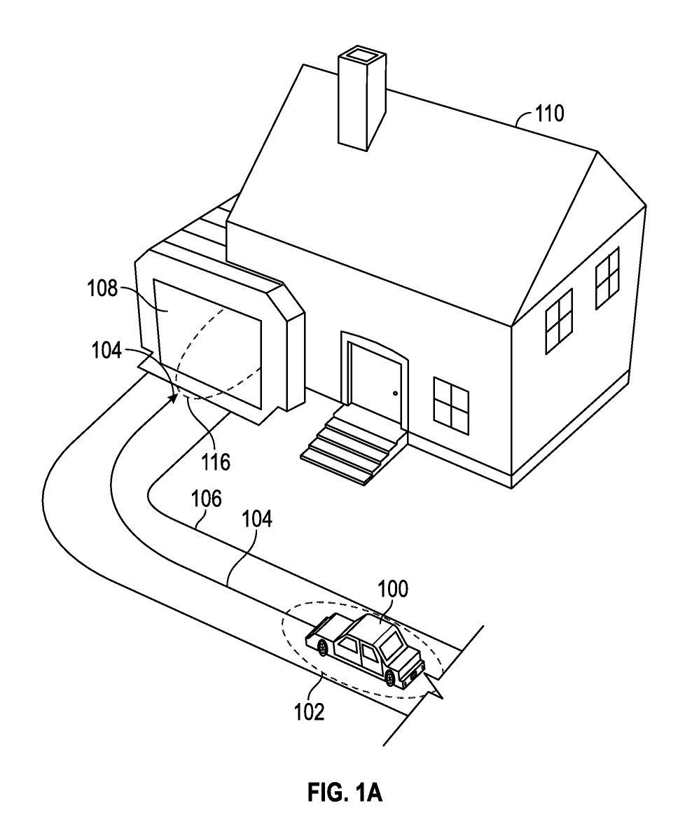

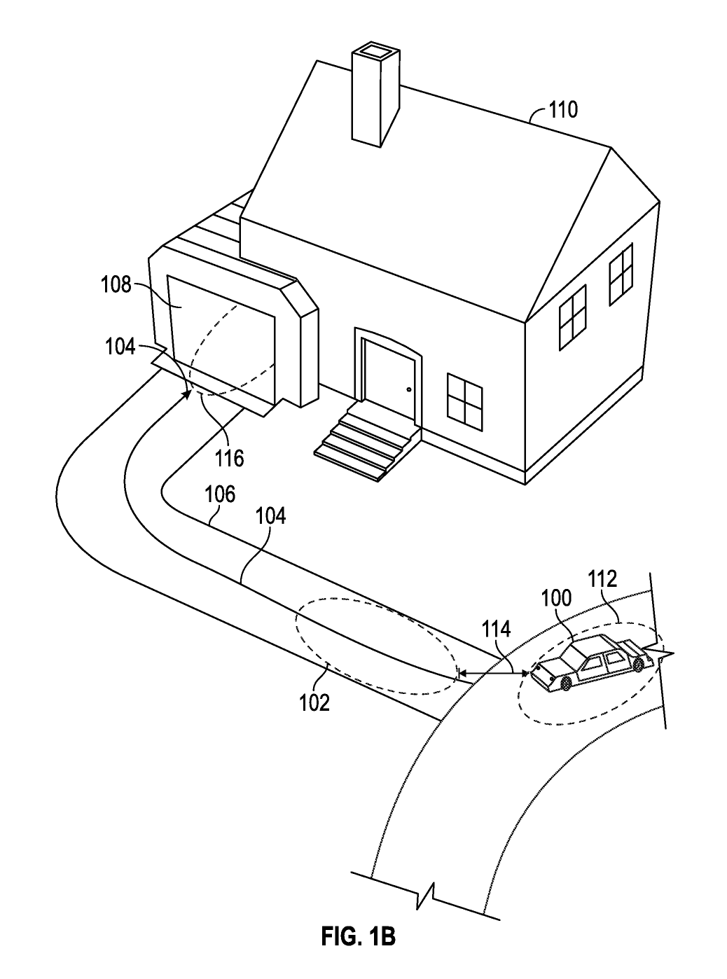

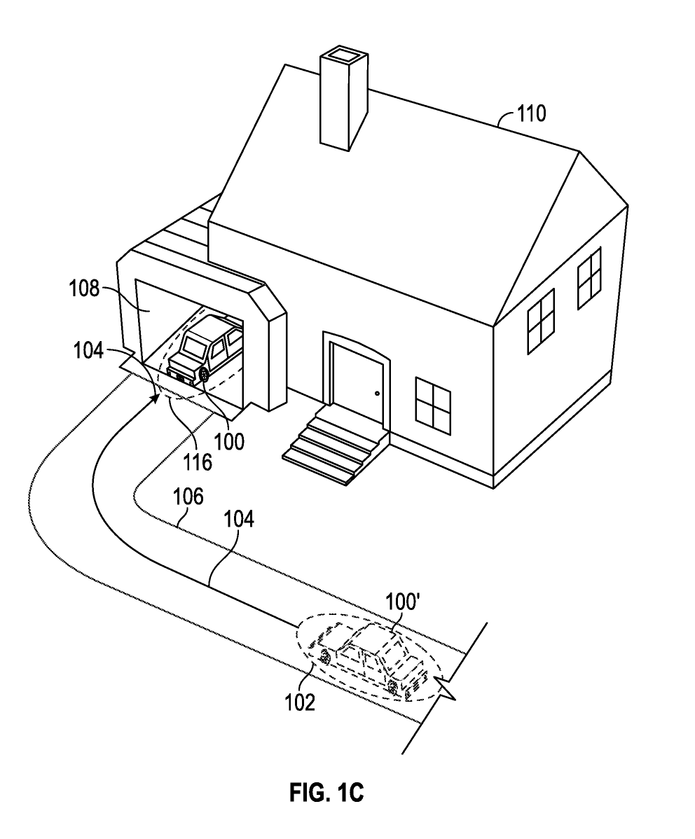

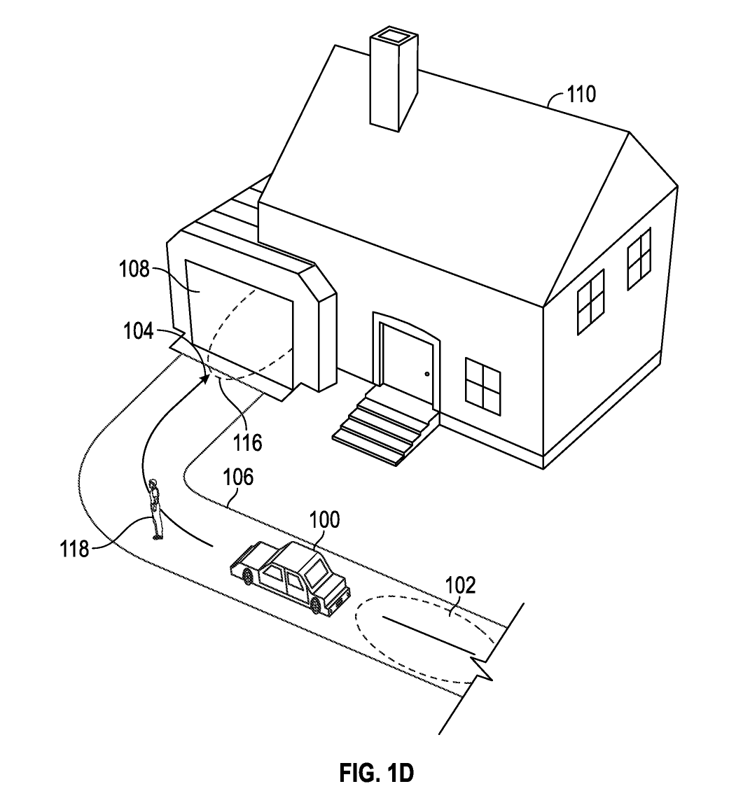

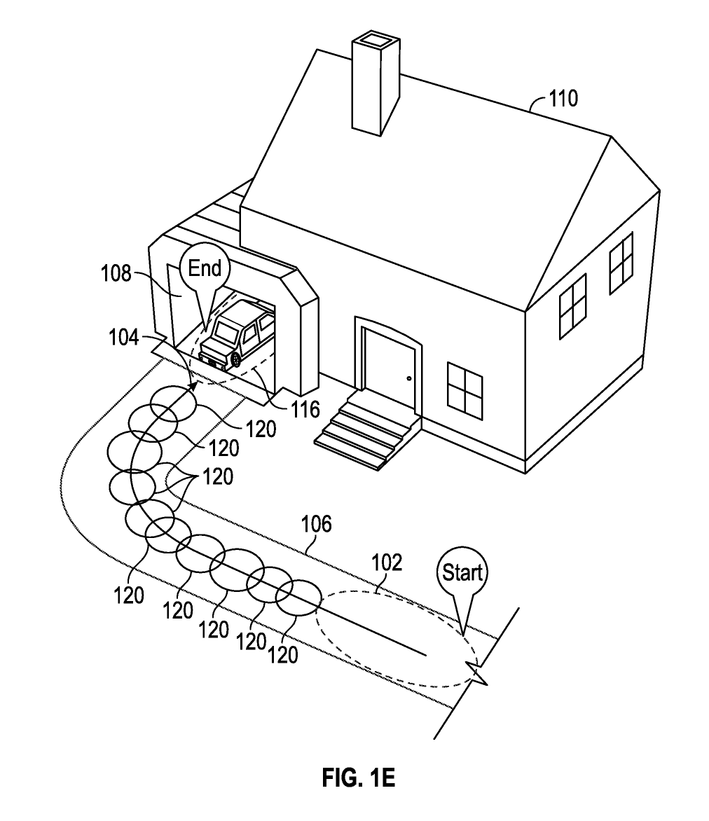

FIGS. 1A-1E illustrate generation and navigation of an exemplary autonomous parking navigation path according to examples of the disclosure. FIG. 1A illustrates exemplary vehicle 100 at a start position 102 of an autonomous parking navigation path 104 according to examples of the disclosure. As illustrated, the autonomous parking navigation path 104 can follow the route of a driveway 106 toward a parking garage 108 of a residence 110. However, it should be understood that the autonomous parking navigation path 104 can include one or more of a parking lot, a driveway, a garage, a road or any geographic location with designated areas for parking and/or driving. When a vehicle 100 arrives at the start position 102, a driver can command the vehicle to begin an autonomous parking maneuver. In some examples, the vehicle 100 can provide an indication and/or notification to a user (e.g., the driver, vehicle owner, and/or another third party) that the start position 102 of an autonomous parking navigation path 104 has been reached. In some examples, the indication can be displayed on a display (e.g., as a pop-up) within the vehicle 100. In some examples, the indication can be displayed (e.g., as a notification) on an accessory and/or a handheld electronic device belonging to the user. The indication can be a phone call, text message, email, or any form of electronic communication to an electronic device (e.g., smartphone or other electronic device) associated with the user. Visual indicators can include one or more of a headlight, a hazard light, a smog light, or any light source on the outside or the inside of the vehicle. The audio indicators can include one or more of a horn, a speaker, an alarm system, and/or any other sound source in the vehicle.

Alternatively, the driver can initiate an autonomous parking maneuver when arriving at a known start location without receiving any indication from the vehicle 100. For example, the driver may prefer to disable notifications of arrival at the start position 102. In such an example, as a first step, when the driver attempts to initiate an autonomous parking maneuver, the vehicle 100 can compare its current position to the start position 102 to determine whether the vehicle is positioned at (or within a predetermined distance of) the starting point or at a position along the autonomous parking navigation path 104 near the starting point. The autonomous navigational parking path 104 can terminate at an end point 116. For example, as illustrated, the end point 116 can be located such that the vehicle 100 is fully positioned within the garage 108 at the end of the autonomous parking maneuver. Navigating the autonomous navigational parking path 104 can require control over numerous aspects of the vehicle. For example, the illustrated path 104 includes a curved path and a garage door of garage 108 that can potentially be closed as the vehicle 100 approaches. For this particular scenario, it is understood that the autonomous parking maneuver for navigating the illustrated path can require control over acceleration (e.g., controlling vehicle 100 speed), steering (e.g., turning the vehicle around the curve), braking (e.g., stopping once end point 116 is reached), transmission gearing (e.g., shifting from park to drive and vice-versa, when appropriate), and communication (e.g., opening/closing the garage door). As will be described below, some or all of these control functions can be performed as a replication of a pre-recorded sequence of events learned by the vehicle 100 during a training session.

FIG. 1B illustrates exemplary behavior of a vehicle 100 when stopped at stopping location 112 at a position away from the start position 102 according to examples of the disclosure. In the example above where vehicle 100 is configured to provide an indication when the vehicle 100 arrives at the start location 102, the user may not receive any indication from the vehicle that an autonomous parking maneuver is available when the vehicle is at illustrated stopping location 112. Alternatively, if the vehicle 100 at stopping location 112 is within a threshold distance 114 from the start position 102, the vehicle may provide an indication and/or notification (e.g., as described above) that the autonomous parking maneuver is available. In some examples, the threshold distance may be on the order of less than a meter such that the amount of driving by the vehicle 100 outside of path 104 is extremely limited. As discussed further below, the autonomous parking navigation path 104 is generated based on recorded driver behaviors, and thus the length of the path 104 is expected to be safe for an autonomous parking maneuver. On the other hand, locations outside of the path can be unknown to an autonomous parking maneuver that relies primarily on GPS position estimates for navigation. Although ultrasonic sensors can be provided to avoid collisions (described in more detail below), a threshold distance 114 for limiting start positions of an autonomous parking maneuver can provide additional safety. At the same time, allowing for minor deviations in start position can allow a user to more easily initiate an autonomous parking maneuver without requiring overly precise positioning of the vehicle 100 by the driver. In other words, this threshold distance 114 can be used to account for an inexact stopping location 112 by the driver at different times (e.g., slightly different stopping locations when returning home at the end of each day). In any event, a threshold distance 114 at least as large as the expected uncertainty of position provided by the chosen GPS (or enhanced GPS) system employed by the vehicle 100 to prevent inaccuracies in position estimation from rendering the autonomous parking system inoperative can be utilized. In some examples, the start position 102 for a stored path can be displayed (e.g., with a small flag or other icon) on a map (which may be derived from a high definition (HD) map or highly automated driving (HAD) map). The flag or icon can assist the driver in properly positioning the vehicle 100 within range for beginning an autonomous parking maneuver as described above.

In some examples, such as when the driver disables indications/notifications that a parking maneuver can begin, the driver may attempt to initiate an autonomous parking maneuver while the vehicle 100 is at the stopping location 112 illustrated in the FIG. 1B. In such an example, if the threshold distance 114 is exceeded, the vehicle may notify the driver (e.g., by any of the indications/notifications described herein) that an autonomous parking maneuver is not available from the current position. In this case, the driver could maneuver the vehicle closer to the start position 102 before an autonomous parking maneuver could be initiated. Alternatively, if the stopping location is within the threshold distance 114 from the start position 102, the vehicle may proceed to navigate from position 112 to the start position 102 along a direct line path (as permitted based on ultrasonic sensor detections), and then proceed along the autonomous parking navigation path 104 until the end point 116 is reached. In some examples, the stopping position 112 of the vehicle can be compared not only with the start position 102, but can be compared to a nearest point on the autonomous parking navigation path 104. If the vehicle 100 is located along the navigational path 104 (not illustrated), the vehicle can begin the autonomous parking maneuver from the closest available waypoint (as will be explained further below). The ability for the automated parking maneuver to resume from a point other than the start position 102 can be useful when navigation is stopped due to presence of an obstacle (as described in more detail below). For example, once the user has verified that the obstacle has been cleared, the user (e.g., the driver, vehicle owner, and/or another third party) can instruct the vehicle to resume the autonomous parking maneuver along path 104 from the vehicle's current location, rather than having to re-enter the vehicle and return it to start position 102 before resuming the maneuver, or simply manually parking the vehicle rather than utilizing the autonomous parking sequence.

FIG. 1C illustrates exemplary vehicle 100 position after the vehicle successfully navigates the driving path 104 according to examples of the disclosure. During the navigation process between the start position 102 and the end point 116, a user (e.g., the driver, vehicle owner, and/or another third party) can monitor the progress of the vehicle on a vehicle display, a remote application, such as a web-based application, mobile device app, or the like (i.e., a user can be at a location inside or outside of the vehicle while monitoring). In some examples, upon successfully reaching the end point 116, the vehicle 100 can autonomously shift into the parking gear. In some examples, the vehicle 100 can autonomously engage the parking brake. Furthermore, in some examples, the vehicle can command a garage door to close behind the vehicle.

FIG. 1D illustrates an exemplary collision avoidance scenario for vehicle 100 during an autonomous parking maneuver according to examples of the disclosure. As illustrated, an obstacle 118 (e.g., a human, a pet, a child's toy, another vehicle or other object) may be positioned along the autonomous parking navigation path 114. In some examples, if vehicle 100 blindly follows the path 114 based on position information alone, the vehicle 100 could collide with the object 118. A desired behavior for the vehicle 100 while navigating along path 114 could be to detect the object 118 and stop moving to avoid a collision. To facilitate the desired collision avoidance behavior, additional sensors (in addition to GPS) can be included with vehicle 100. In some examples, one or more cameras could be used for object detection and avoidance. In some examples, object detection using camera data can require significant computational resources, such as analysis of millions of image data pixels. In addition, camera based detection can potentially fail to detect an object 118 and stop the vehicle 100 due to variations in lighting, low-light, rain, fog, and other poor visibility conditions. In some examples, ultrasonic sensors can be used for detecting an object 118. Ultrasonic sensors (alternatively referred to as ultrasonic proximity sensors), can operate by transmitting ultrasonic signals outwardly from exterior surfaces of vehicle 100. When an object 118 is present within the sensing range of the ultrasonic sensor, energy can be reflected from the object and sensed by the ultrasonic sensors. An exemplary sensing range for an ultrasonic sensor can be between fifteen centimeters and three meters. In some examples, attenuation and reflection of the ultrasonic signal very near to the vehicle 100 can create a blind zone near the outer edges of the vehicle (e.g., within approximately 15 centimeters distance from the device). As described above, a desirable behavior for collision avoidance can be to stop the vehicle and pause, halt, or end the autonomous parking maneuver when an object is detected the ultrasonic sensor (or camera, or other suitable sensor). As described above, a user (e.g., the driver, vehicle owner, and/or another third party) can, in some examples, command the vehicle to resume the autonomous parking maneuver from the pause point after verifying that the path is clear. In some examples, the vehicle can be stopped and the autonomous parking maneuver can pause, halt, or end only if an object is detected in a position along the planned trajectory that may result in a collision if the vehicle continues to move.

FIG. 1E illustrates a visualization of exemplary waypoints 120 that can be obtained from GPS measurements during a recording sequence for generating an autonomous parking navigation path (e.g., 104 above). From the driver's perspective, the recording sequence can be as simple as initiating a recording sequence, navigating the vehicle 100 along the driver's typical path used for parking, and shifting the vehicle into park once the destination (e.g., a garage or designated parking spot) is reached. In some examples, the driver can initiate a recording sequence by selecting an option in a user interface displayed on a display within the vehicle 100, pressing a physical record button in the vehicle, initiating a record option in a mobile application, activating a record mode on a keyfob or other accessory, or other similar action. The recording sequence can obtain a position measurement (e.g., from a GPS system as described below) for the initial position of the vehicle 100 and optionally provide the first measurement obtained with a special designation of start position 102. In some examples, the vehicle may recognize that the first stored position in a recorded sequence is a start position 102 without requiring a special designation. In some examples, because GPS (or even enhanced GPS) has uncertainty in position information, the position measurements can be stored as small circles (or ovals, rectangles, or irregular shapes) corresponding to the estimated position obtained from a position measurement. In some examples, a centroid of the circle can be stored in addition to (or instead of) information fully describing the circle. As the vehicle continues to drive the vehicle, the GPS can periodically provide position measurements (on the order of one measurement per second), and each of the measurements can be recorded as a trail of waypoints 120. In some examples, the frequency of recording can be based on the degree of change in vehicle dynamics (e.g., if the vehicle is turning, accelerating, decelerating, etc., the frequency of recording can be greater than if the vehicle is moving in a straight line at a fixed speed). The trail of waypoints 120 can terminate at an end point 116 when the driver shifts the vehicle into park, or otherwise instructs the vehicle to end a recording. In some examples, the waypoints 120 can include only GPS measurement data that can be used to generate an autonomous navigation parking path 104. In a simple scenario, the autonomous navigation parking path 104 can simply be a series of segments that connects between the center points of the trail of waypoints 120. In some scenarios, depending on the uncertainty of the position measurements (e.g., from GPS) and spacing between the waypoints 120, a vehicle 100 following the path 104 may appear to be moving somewhat erratically. In some examples, the autonomous navigation parking path 104 can be smoothed by various techniques. In one example, the path can be generated based on a curve fitting based on the waypoints 120. In some examples, measurements from an inertial measurement unit (IMU) can be used to assist in generating the path 104. An IMU can provide information such as force, acceleration, and orientation of the vehicle 100. During the recording process, the vehicle 100 can store both the GPS information and IMU information in the waypoints 120. Measurements from an IMU can occur at a greater frequency than GPS measurements, thus effectively being capable of filling in gaps in the relatively slowly sampled GPS data (e.g., at a frequency of 1 Hz), as well as being available for GPS compensating measurement uncertainty (e.g., as a sanity check on a trajectory produced from GPS data alone). In some examples, information from multiple sets of measurements (e.g., GPS and IMU) can be combined to form an autonomous navigation parking path 104. It should be understood that although IMU data may be used to generate waypoints 120, a vehicle subsequently following the autonomous navigation parking path 104 does not necessarily have to match the speed recordings recorded by the IMU. In some examples, it may be preferred that the vehicle speed during an autonomous parking maneuver be significantly reduced in order to minimize damage that could be caused by an inadvertent collision with an object (e.g., 118 above).

In some examples, once a recording sequence is complete, the vehicle 100 can use the recorded autonomous navigation parking path 104 to perform an autonomous parking maneuver. As described above in FIGS. 1A-1D, the vehicle 100 can perform the autonomous parking maneuver by moving the vehicle, and making course adjustments based on a comparison(s) between the vehicle's current detected position and the autonomous navigation parking path 104 and/or waypoints 102, and continuing along the path 104 until an end point 116 is reached.

In the examples above for FIGS. 1A-1E, the vehicle is described as comparing its current position to a start position 102, an end position 116, and/or positions along an autonomous vehicle navigation path 104 (e.g., corresponding to waypoints 120) during an autonomous parking maneuver. In some examples, the vehicle can obtain its current position using GPS (or other analogous Global Navigational Satellite Systems). In some examples, standard GPS systems rely on information from four navigational satellites to provide a position estimate (three for distance information, and one for timing information). In some examples, a standard GPS system can provide position information at a resolution precision of approximately 5-15 meters. For example, in dense urban areas, the resolution of a standard GPS system can approach worst case resolution values of 10-15 m due errors that can be caused by, e.g., multiple reflections occurring from tall buildings (also known as multipath propagation). It can be difficult for an autonomous vehicle to follow a navigation parking path 104 when relying on position information at the standard level of GPS position resolution (i.e., on the order of several meters). The example accuracy of 5-15 m can be significantly in excess of the width of the vehicle and the road/path to be followed.

Variations/enhancements of the standard GPS system can be used to provide improved accuracy in position information. In some examples, Differential GPS (DGPS) systems can provide accuracy at the level of 1-10 cm. DGPS systems can utilize position information from fixed GPS receiver positions with known locations to provide offset information to a DGPS receiver in a vehicle. As a lower cost alternative to the differential GPS system, automotive grade GPS can utilize cellular and/or additional GPS satellite signals (in addition to the minimum requirement of four) to perform differential correction to enhance the GPS position resolution to approximately 10-15 cm. Differentially corrected (or high-accuracy) automotive grade GPS can accordingly provide an acceptable level of certainty of vehicle position for keeping the vehicle on a road 106 or other designated path while following the autonomous parking navigation path 104. In some examples, when the vehicle is within range of cellular signals from one or more cellular base stations, information about known locations (e.g., locations stored in a base station almanac) of the cellular communication network base stations can be combined with the GPS output to improve position estimate accuracy. This cellular enhanced GPS can require a cellular communication chip (e.g., 4G, LTE, CDMA, GSM, etc.) on the vehicle to allow for wireless communication with the cellular network. In some examples, when more than the minimum four GPS satellites (e.g., five or more GPS satellites) are within the line of sight of an automotive GPS receiver, the information from additional satellites can be used to improve the position information accuracy to within a meter. While several specific examples of GPS enhancement are disclosed herein, it should be understood that other analogous techniques for enhancing GPS accuracy can be utilized while remaining within the scope of the present disclosure. Navigation using the GPS data can further be enhanced by utilizing measurements from an inertial measurement unit (IMU) for providing dead-reckoning and/or position keeping in between intervals of GPS data updates, which can occur at an approximate frequency of 1 Hz. The IMU can be used to ensure that the vehicle remains on the desired trajectory (i.e., autonomous parking navigation path 104) between the relatively slow refresh periods of the GPS. Analogously, IMU data can be used during generation of the autonomous parking navigation path 104 to fill in gaps in GPS position data, generally allowing for a smoother navigation path.

As briefly described above, although many vehicles can be equipped with one or more camera sensors that can be used for performing an autonomous parking maneuver based on visual cues, image based techniques can be highly susceptible to variations in lighting conditions, and can be largely ineffective in low illumination scenarios. On the contrary, the GPS systems described above can perform effectively in different lighting scenarios at any time of the day as long as a line of sight can be established with the requisite number of satellites (e.g., four GPS satellites for standard GPS functionality). Similarly, a camera based solution may have difficulty detecting obstacles in low illumination scenarios, rain, fog, and other poor visibility conditions. The ultrasonic sensors (which are described above for use in collision avoidance) can operate more reliably than cameras in poor visibility conditions. Accordingly, the combination of GPS, ultrasonic sensors, and an optional IMU can be effectively used to perform autonomous parking maneuvers without utilizing camera data at all. The autonomous parking maneuver can follow a previously recorded navigation path based on position information. This path-following approach can have significantly reduced computational requirements relative to a camera-based solution that processes large amounts of image data to produce navigation commands.

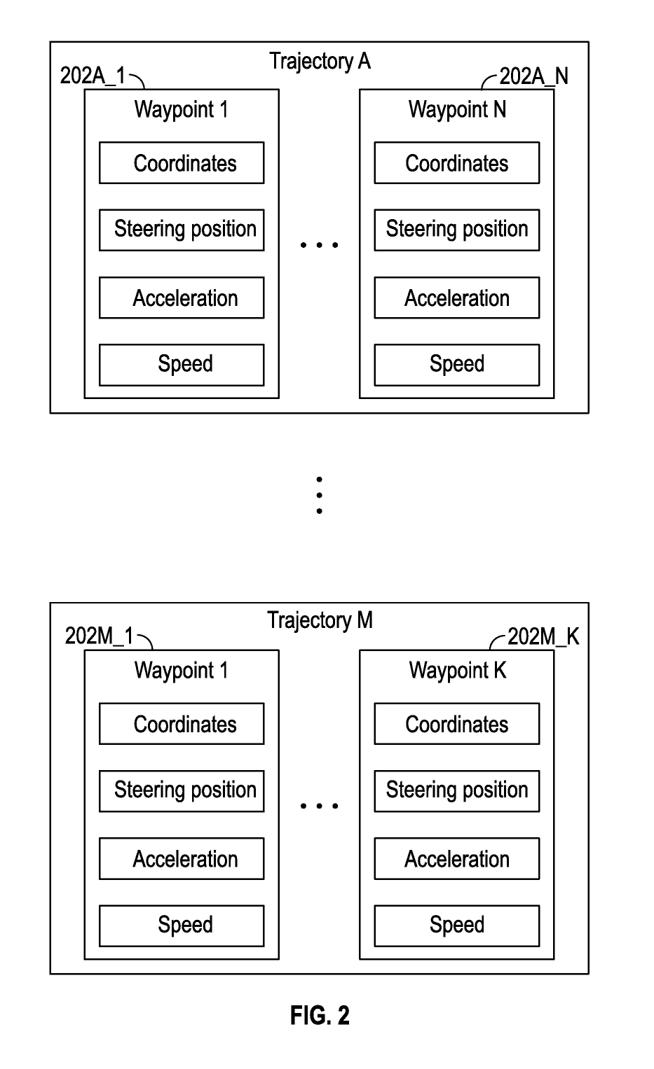

FIG. 2 illustrates an exemplary data structure for storing position information (e.g., waypoints 120 above) for a stored navigation path or trajectory (e.g., autonomous navigation parking path 104) according to examples of the disclosure. The data structure described can include a plurality of trajectories (e.g., trajectory A to trajectory M) that can correspond to multiple recorded paths. For example, a single user of the vehicle (e.g., vehicle 100 above) can store a first trajectory for parking at a designated parking space in an outdoor work parking lot in the morning, and a second trajectory for parking at a garage located at the end of a driveway. Similarly, multiple users may share use of the vehicle such that additional trajectories may need to be stored. Each trajectory can include a plurality of waypoints corresponding to position measurements of the vehicle recorded as described above. In the illustrated example, trajectory A is illustrated as having an integer number n waypoints 202A_1 through 202A_n, and trajectory M is illustrated as having an integer number k waypoints 202M_1 through 202M_k. It should be understood that the number of waypoints for a particular trajectory can be dependent upon the length of the path, speed of the vehicle during the recording process, frequency of position measurements, and other related factors. Each waypoint can contain information about a measured position of the vehicle (e.g., vehicle 100) at a point in time along the trajectory A. The position can be a latitude and longitude coordinate, or as explained above, may be stored as a circle (or other shape) representative of a zone of uncertainty of the recorded position. In some examples, additional information can also optionally be stored in the waypoints (as described above) including steering position, acceleration, speed, start/end flags (not shown) or other relevant information that can be used to aid in successful navigation along a pre-recorded trajectory. In addition or in the alternative to the waypoints, a continuous autonomous navigation parking path (e.g., 104 above) can be stored for each trajectory. In either case, a vehicle (e.g., vehicle 100 above) can follow the trajectory based on comparisons between current measured position of the vehicle and the information stored in the trajectory that is being followed.

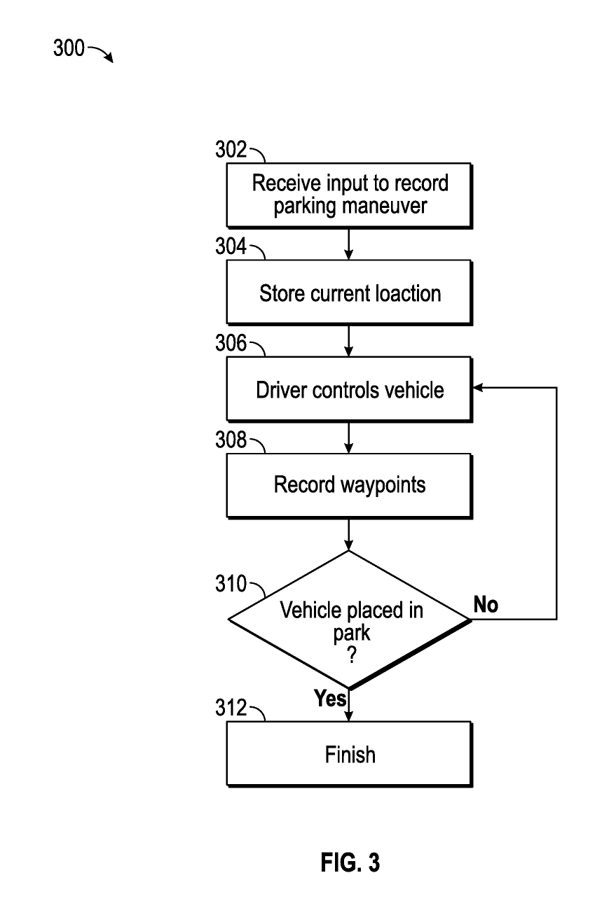

FIG. 3 illustrates a flow diagram of a recording sequence 300 (which can correspond to the recording sequence described for FIG. 1E above) according to examples of the disclosure. In some examples, at step 302, recording sequence 300 can receive an input from a user (e.g., the driver, vehicle owner, and/or another third party) to begin recording of a parking maneuver. In some examples, at step 304, the recording sequence 300 can record the current position of the vehicle, which can be a start position (e.g., start position 102 above) for the recording sequence. In some examples, at step 306, the driver can control the vehicle, particularly steering and acceleration of the vehicle. In some examples, at step 308, the recording process 300 can record waypoints (e.g., waypoints 120 above) that can correspond to position information and other information as described above for FIGS. 1E and 2. At step 310, the recording process 300 can determine whether the recording sequence has ended. As described above, the recording sequence can be ended by the vehicle being placed into a parking gear, or by another command from the user that the recording sequence should end (as described above). If at step 310 it is determined that the recording process 300 should not end, steps 306-310 can repeat, successively recording additional waypoints corresponding to the driving path of the vehicle 100 as controlled by the driver. However, if it is determined at step 310 that the recording process 300 should end, process 300 can terminate at step 312. In some examples, the final waypoint can optionally be marked as an endpoint of the recorded trajectory.

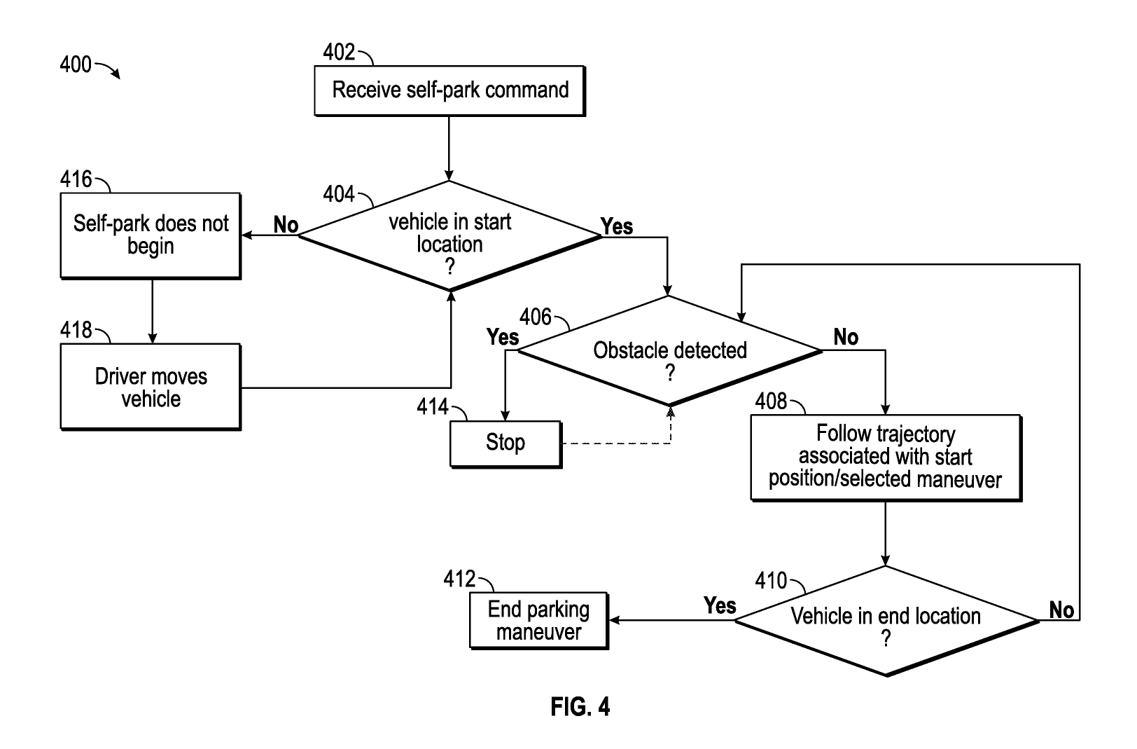

FIG. 4 illustrates an exemplary autonomous parking process 400 for executing an autonomous parking maneuver according to examples of the disclosure. In some examples, at step 402, the autonomous parking process 400 can receive a self-park command (e.g., a command to perform an autonomous parking maneuver). In some examples, at step 404, the autonomous parking process 400 can determine whether the vehicle (e.g., vehicle 100 above) is located in a start location of the navigation path, or within a threshold distance of the start location (e.g., start position 102 above) as described above. In some examples, a vehicle can provide a starting point indication (e.g., a flag, pointer, or other icon) on a map to assist the driver in correctly positioning the vehicle as described above. In some examples, as described above, prior to receiving a self-park command, the vehicle (e.g., vehicle 100 above) can provide an indication to a user that the vehicle is located at a start location of an autonomous navigation parking path (e.g., 104 above). In such an example, an affirmative step of verifying that the vehicle is in the start location at step 404 can still be advantageous as a verification step. If at step 404 it is determined that the vehicle is not at the start location or within a threshold distance of the start location, at step 416 the autonomous parking maneuver may not begin. At step 418, the driver can retain control of the vehicle, and can optionally move the vehicle to the start location. In some examples, at step 416, the autonomous parking process 400 can notify the driver that the start location has been reached, and can prompt the driver (or another user) to resume the autonomous parking process at step 404. In some examples, if at step 404 it is determined that the vehicle is not at the start location or within a threshold distance of the start location, the autonomous parking process 400 can return to step 402 (not shown) and await a self-park command from the driver (or another user).

If at step 404 it is determined that the vehicle is at the start location, the autonomous parking process 400 can determine whether an obstacle (e.g., obstacle 118 above) is detected along the vehicle's path. If an obstacle is detected at step 406, the vehicle can stop at step 414 and the autonomous parking process 400 can stop or be suspended. In some examples, the vehicle may only stop or suspend at step 414 if an object is detected in a position along the planned trajectory that may result in a collision if the vehicle continues to move. In some examples, a user may have to manually restart the autonomous parking process 400 once an object is detected. In particular, where ultrasonic sensors are used, an obstacle that has moved closer to the vehicle may enter a blind zone of the ultrasonic sensor (as described above), and it can be unsafe to resume the autonomous parking process 400 without verification from the user. In some examples, if no object is detected at step 406, the vehicle can be maneuvered along the trajectory of the autonomous navigation parking path at step 408. In some examples, at step 410, the autonomous parking process 400 can determine whether the vehicle is at an end location (e.g., end position 116 above). If it is determined at step 410 that the vehicle is at the end location, the process can proceed to step 412, where the autonomous parking process 400 can be terminated. At step 412, the vehicle can be placed into a parking gear, a parking brake can be initiated, and an indication or notification (as described above) can be provided to the user to indicate the end of the parking maneuver. However, if at step 410 it is determined that the vehicle is not at the end position, steps 406 and 408 can repeated to navigate the vehicle while avoiding obstacle collision along the navigation path until the vehicle eventually does reach the ending position. As should be understood from the disclosure above, the processes 300 and 400 described above can be used together as an exemplary process implementation of the autonomous parking maneuver and recording described in FIGS. 1A-1E above.

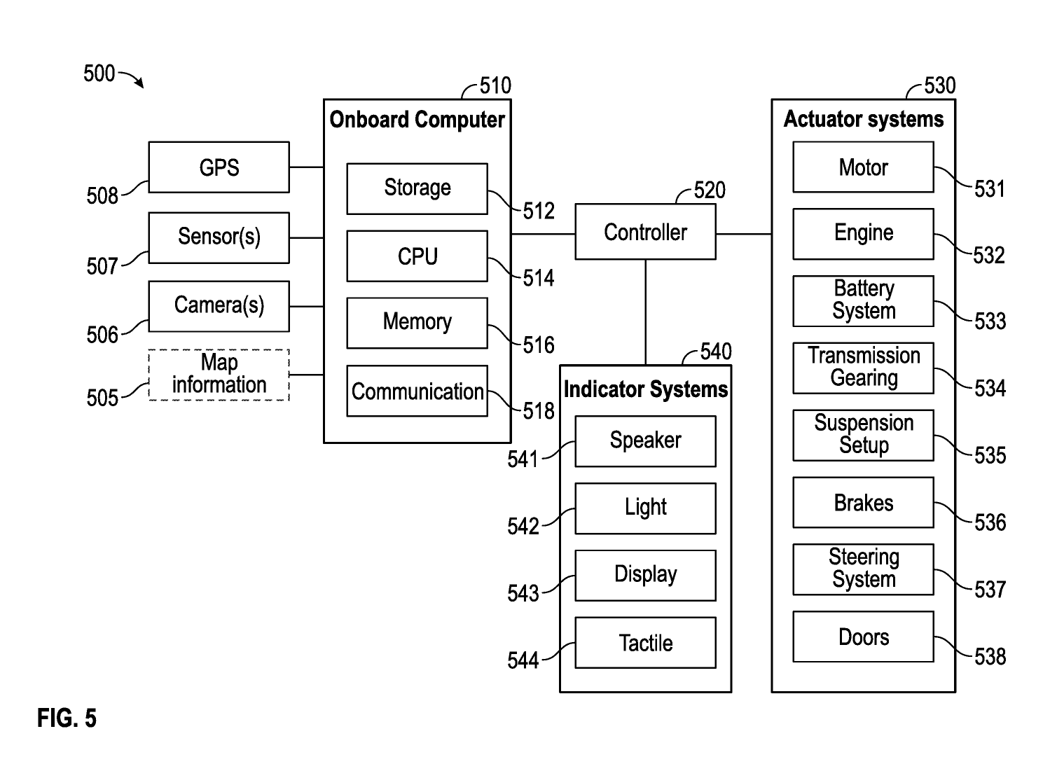

FIG. 5 illustrates an exemplary system block diagram of vehicle control system 500 according to examples of the disclosure. Vehicle control system 500 can perform any of the methods described with reference to FIGS. 1A-1E and 2-4. System 500 can be incorporated into a vehicle, such as a consumer automobile. Other example vehicles that may incorporate the system 500 include, without limitation, airplanes, boats, or industrial automobiles. Vehicle control system 500 can include one or more cameras 506 capable of capturing image data (e.g., video data) for determining various characteristics of the vehicle's surroundings, as described above. Vehicle control system 500 can also include one or more other sensors 507 (e.g., radar, ultrasonic, LIDAR, etc.) capable of detecting various characteristics of the vehicle's surroundings, and a Global Positioning System (GPS) receiver 508 capable of determining the location of the vehicle. As described above, the GPS receiver 508 in combination with an ultrasonic sensor 507 can be utilized to perform an autonomous parking maneuver as described in relation to FIGS. 1A-1E and 2-4. Vehicle control system 500 can also optionally receive (e.g., via an internet connection) map information and/or zone information via an optional map information interface 505 (e.g., a cellular internet interface, a Wi-Fi internet interface, etc.). As described above, a flag or other icon indicating a parking maneuver starting point can be overlaid on a map to assist a user in locating the starting point.

Vehicle control system 500 can include an on-board computer 510 that is coupled to the cameras 506, sensors 507, GPS receiver 508, and optional map information interface 505, and that is capable of receiving the image data from the cameras and/or outputs from the sensors 507, the GPS receiver 508, and map information interface 505. The on-board computer 510 can be capable of recording a navigation path (e.g., path 104 above) based on GPS receiver 508 (or enhanced GPS) data obtained during a recording operation (e.g., as illustrated in FIG. 3). The on-board computer 510 can further be used to autonomously navigate the vehicle along the navigation path (e.g., path 104 above), again using the GPS receiver 508 (or enhanced GPS) data for comparing the vehicle position to the navigation path as well as utilizing an ultrasonic sensor 507 for collision avoidance (e.g., as illustrated in FIGS. 1A-1E and FIG. 4). On-board computer 510 can include storage 512, memory 516, communications interface 518, and a processor 514. Processor 514 can perform any of the methods described with reference to FIGS. 1A-1E and 2-4. Additionally, communications interface 518 can perform any of the communication notifications described with reference to the examples above. Moreover, storage 512 and/or memory 516 can store data and instructions for performing any of the methods described with reference to FIGS. 1A-1E and 2-4. Storage 512 and/or memory 516 may also be used for storing navigation path data waypoints (e.g., waypoints 202 above). Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation, such as performing autonomous parking maneuvers to navigate the vehicle along an autonomous parking navigation path according to instructions from on-board computer 510.

In some examples, the vehicle control system 500 can be connected to (e.g., via controller 520) one or more actuator systems 530 in the vehicle and one or more indicator systems 540 in the vehicle. The one or more actuator systems 530 can include, but are not limited to, a motor 531 or engine 532, battery system 533, transmission gearing 534, suspension setup 535, brakes 536, steering system 537 and door system 538. The vehicle control system 500 can control, via controller 520, one or more of these actuator systems 530 during vehicle operation; for example, to control the vehicle during autonomous driving or parking operations, which can utilize the error bounds, map, and zones determined by the on-board computer 510, using the motor 531 or engine 532, battery system 533, transmission gearing 534, suspension setup 535, brakes 536 and/or steering system 537, etc. Actuator systems 530 can also include sensors that send dead reckoning information (e.g., steering information, speed information, etc.) to on-board computer 510 (e.g., via controller 520) to estimate the vehicle's position and orientation. The one or more indicator systems 540 can include, but are not limited to, one or more speakers 541 in the vehicle (e.g., as part of an entertainment system in the vehicle), one or more lights 542 in the vehicle, one or more displays 543 in the vehicle (e.g., as part of a control or entertainment system in the vehicle) and one or more tactile actuators 544 in the vehicle (e.g., as part of a steering wheel or seat in the vehicle). The vehicle control system 500 can control, via controller 520, one or more of these indicator systems 540 to provide visual and/or audio indications that the vehicle has reached a navigation starting point (e.g., start position 102 above), encountered an obstacle (e.g., 118 above), or the vehicle has successfully completed navigation by reaching an end point (e.g., 116 above) as determined by the on-board computer 510.

Therefore, according to the above, some examples of the disclosure are directed to a system comprising: a position sensor, a proximity sensor, one or more processors coupled to the position sensor and the proximity sensor, and a memory including instructions, which when executed by the one or more processors, cause the one or more processors to perform a method comprising: receiving a current vehicle position from the position sensor, autonomously navigating a vehicle along a stored navigational path based on a comparison between the current vehicle position and one or more of a plurality of waypoints associated with the stored navigational path, while autonomously navigating the vehicle along the stored navigational path, determining, using the proximity sensor, whether an obstacle is present proximate to the vehicle; and in accordance with a determination that the obstacle is present proximate to the vehicle, halting the autonomous navigation of the vehicle. Additionally or alternatively to one or more of the examples disclosed above, in some examples, the position sensor includes a global positioning system receiver and the proximity sensor is an ultrasonic proximity sensor. Additionally or alternatively to one or more of the examples disclosed above, in some examples, the position sensor is a global positioning system and an accuracy of the global positioning system is enhanced by position information received from a telecommunications network. Additionally or alternatively to one or more of the examples disclosed above, in some examples, the method further comprises: receiving a user input indicative of a request to record a second navigational path; and in response to receiving the user input indicative of the request to record a second stored navigational path, recording a second plurality of stored locations based on the current vehicle position received from the position sensor, wherein the second plurality of stored locations includes a beginning location and an end location of the second stored navigational path. Additionally or alternatively to one or more of the examples disclosed above, in some examples, ending the autonomous navigation comprises shifting the vehicle into a parking gear. Additionally or alternatively to one or more of the examples disclosed above, in some examples, autonomously navigating the vehicle occurs in a low-lighting condition. Additionally or alternatively to one or more of the examples disclosed above, in some examples, autonomously navigating the vehicle includes varying vehicle speed and changing steering direction. Additionally or alternatively to one or more of the examples disclosed above, in some examples, ending the autonomous navigation comprises electronically engaging a parking brake mechanism. Additionally or alternatively to one or more of the examples disclosed above, in some examples, the method further comprises: in accordance with a determination that there is no obstacle present proximate to the vehicle, maneuvering the vehicle toward a subsequent waypoint of the plurality of waypoints associated with the stored navigational path relative to the current vehicle position from the position sensor. Additionally or alternatively to one or more of the examples disclosed above, in some examples, autonomously navigating the vehicle comprises determining desired movement of the vehicle, the determining based only on proximity data from the proximity sensor, position data from the position sensor, and the stored navigational path. Additionally or alternatively to one or more of the examples disclosed above, in some examples, the method further comprises: in accordance with the determination that the obstacle is present proximate to the vehicle, transferring control of the vehicle to a user; and resuming autonomously navigating the vehicle based on a determination that no obstacle is present proximate to the vehicle. Additionally or alternatively to one or more of the examples disclosed above, in some examples, resuming autonomously navigating the vehicle further is further based on an input from the user indicative of a request to resume autonomous navigation. Additionally or alternatively to one or more of the examples disclosed above, in some examples, the method further comprises: receiving an input indicative of a request to initiate an autonomous navigation maneuver; comparing the current vehicle position with one or more waypoints of the stored navigational path; and in accordance with a determination that the vehicle is not located at a starting point of the stored navigation path and the current vehicle position is proximate to a proximate waypoint of the stored navigational path, initiating autonomously navigating the vehicle along the stored navigational path beginning at the proximate waypoint, wherein one or more waypoints of the plurality of waypoints define the start position of the stored navigational path. Additionally or alternatively to one or more of the examples disclosed above, in some examples, the method further comprises: in accordance with a determination that the vehicle is not located at a starting point of the stored navigation path and the current vehicle position is not proximate to any waypoint of the stored navigational path; in accordance with a determination that the vehicle is within a threshold distance of the starting point of the stored navigation path: autonomously navigating the vehicle to the starting point of the stored navigational path along a path that is not included in the stored navigational path; and upon reaching the starting point, autonomously navigating the vehicle along the stored navigational path.

Some examples of the disclosure are directed to a non-transitory computer-readable medium including instructions, which when executed by one or more processors, cause the one or more processors to perform a method comprising: receiving a current vehicle position from a position sensor, autonomously navigating a vehicle along a stored navigational path based on a comparison between the current vehicle position and one or more of a plurality of waypoints associated with the stored navigational path, while autonomously navigating the vehicle along the stored navigational path, determining, using a proximity sensor, whether an obstacle is present proximate to the vehicle, and in accordance with a determination that the obstacle is present proximate to the vehicle, halting the autonomous navigation of the vehicle.

Some examples of the disclosure are directed to a vehicle comprising: a position sensor, a proximity sensor, one or more processors coupled to the position sensor and the proximity sensor, and a memory including instructions, which when executed by the one or more processors, cause the one or more processors to perform a method comprising: receiving a current vehicle position from the position sensor, autonomously navigating a vehicle along a stored navigational path based on a comparison between the current vehicle position and one or more of a plurality of waypoints associated with the stored navigational path, while autonomously navigating the vehicle along the stored navigational path, determining, using the proximity sensor, whether an obstacle is present proximate to the vehicle; and in accordance with a determination that the obstacle is present proximate to the vehicle, halting the autonomous navigation of the vehicle.

Some examples of the disclosure are directed to a method comprising: receiving a current vehicle position from a position sensor, autonomously navigating a vehicle along a stored navigational path based on a comparison between the current vehicle position and one or more of a plurality of waypoints associated with the stored navigational path, while autonomously navigating the vehicle along the stored navigational path, determining, using a proximity sensor, whether an obstacle is present proximate to the vehicle, and in accordance with a determination that the obstacle is present proximate to the vehicle, halting the autonomous navigation of the vehicle.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
a position sensor;
a proximity sensor;
one or more processors coupled to the position sensor and the proximity sensor; and
a memory including instructions, which when executed by the one or more processors, cause the one or more processors to perform a method comprising:
receiving a current vehicle position from the position sensor;
autonomously navigating a vehicle along a stored navigational path based on a comparison between the current vehicle position and one or more of a plurality of waypoints associated with the stored navigational path;
while autonomously navigating the vehicle along the stored navigational path, determining, using the proximity sensor, whether an obstacle is present proximate to the vehicle; and
in accordance with a determination that the obstacle is present proximate to the vehicle, halting the autonomous navigation of the vehicle.

2. The system of claim 1, wherein the position sensor includes a global positioning system receiver and the proximity sensor is an ultrasonic proximity sensor.

3. The system of claim 1, wherein the position sensor is a global positioning system receiver and an accuracy of the global positioning system is enhanced by position information received from a telecommunications network.

4. The system of claim 1, wherein the method further comprises:
receiving a user input indicative of a request to record a second navigational path; and
in response to receiving the user input indicative of the request to record a second stored navigational path, recording a second plurality of stored locations based on the current vehicle position received from the position sensor, wherein the second plurality of stored locations includes a beginning location and an end location of the second stored navigational path.

5. The system of claim 1, wherein ending the autonomous navigation comprises shifting the vehicle into a parking gear.

6. The system of claim 1, wherein autonomously navigating the vehicle occurs in a low-lighting condition.

7. The system of claim 1, wherein autonomously navigating the vehicle includes varying vehicle speed and changing steering direction.

8. The system of claim 1, wherein ending the autonomous navigation comprises electronically engaging a parking brake mechanism.

9. The system of claim 1, wherein the method further comprises:
in accordance with a determination that there is no obstacle present proximate to the vehicle, maneuvering the vehicle toward a subsequent waypoint of the plurality of waypoints associated with the stored navigational path relative to the current vehicle position from the position sensor.

10. The system of claim 1, wherein autonomously navigating the vehicle comprises determining desired movement of the vehicle, the determining based only on proximity data from the proximity sensor, position data from the position sensor, and the stored navigational path.

11. The system of claim 1, wherein the method further comprises:
in accordance with the determination that the obstacle is present proximate to the vehicle, transferring control of the vehicle to a user; and
resuming autonomously navigating the vehicle based on a determination that no obstacle is present proximate to the vehicle.

12. The system of claim 11, wherein resuming autonomously navigating the vehicle further is further based on an input from the user indicative of a request to resume autonomous navigation.

13. The system of claim 1, wherein the method further comprises:
receiving an input indicative of a request to initiate an autonomous navigation maneuver;
comparing the current vehicle position with one or more waypoints of the stored navigational path; and
in accordance with a determination that the vehicle is not located at a starting point of the stored navigation path and the current vehicle position is proximate to a proximate waypoint of the stored navigational path, initiating autonomously navigating the vehicle along the stored navigational path beginning at the proximate waypoint, wherein one or more waypoints of the plurality of waypoints define the start position of the stored navigational path.

14. The system of claim 13, wherein the method further comprises:
in accordance with a determination that the vehicle is not located at a starting point of the stored navigation path and the current vehicle position is not proximate to any waypoint of the stored navigational path;
in accordance with a determination that the vehicle is within a threshold distance of the starting point of the stored navigation path:
autonomously navigating the vehicle to the starting point of the stored navigational path along a path that is not included in the stored navigational path; and
upon reaching the starting point, autonomously navigating the vehicle along the stored navigational path.

15. A non-transitory computer-readable medium including instructions, which when executed by one or more processors, cause the one or more processors to perform a method comprising:
receiving a current vehicle position from a position sensor;
autonomously navigating a vehicle along a stored navigational path based on a comparison between the current vehicle position and one or more of a plurality of waypoints associated with the stored navigational path;
while autonomously navigating the vehicle along the stored navigational path, determining, using a proximity sensor, whether an obstacle is present proximate to the vehicle; and
in accordance with a determination that the obstacle is present proximate to the vehicle, halting the autonomous navigation of the vehicle.

16. A method comprising:
receiving a current vehicle position from a position sensor;
autonomously navigating a vehicle along a stored navigational path based on a comparison between the current vehicle position and one or more of a plurality of waypoints associated with the stored navigational path;
while autonomously navigating the vehicle along the stored navigational path, determining, using a proximity sensor, whether an obstacle is present proximate to the vehicle; and
in accordance with a determination that the obstacle is present proximate to the vehicle, halting the autonomous navigation of the vehicle.
